(19) United States
(12) Patent Application Publication
(10) Pub. No.: US 2007/0053514 A1
(43) Pub. Date: Mar. 8, 2007

(54) Continuous content playback system

(75) Inventors: Shigeru Imai, Tokyo (JP); Shin Miura, Tokyo (JP); Masami Matsubara, Tokyo (JP); Takehiko Hanada, Tokyo (JP); Shinji Akatsu, Tokyo (JP)

Correspondence Address: BIRCH STEWART KOLASCH & BIRCH, PO BOX 747, FALLS CHURCH, VA, 22040-0747, US

(73) Assignee: Mitsubishi Denki Kabushiki Kaisha

(21) Appl. No.: 11/376,252

(22) Filed: Mar. 16, 2006

(30) Foreign Application Priority Data
Sep. 8, 2005 (JP) 2005-260951

(51) Int. Cl. H04N 7/167

(52) U.S. Cl. 380/204

(57) ABSTRACT

A mobile terminal 100 holds identification information indicating specific content which the user has been viewing and listening to, and a playback position of the content. When receiving a request for continuous playback of the specific content from the user, the mobile terminal 100 acquires the storage location of the specific content in a content server terminal A or B (200a or 200b), and sends information indicating this storage location and an instruction for continuous playback of the content to a content playback terminal 300. The content playback terminal 300 then reads the specific content from the storage location of the content server A or B (200a or 200b), and carries out a continuous playback of the content.

### BACKGROUND OF THE INVENTION

1. Field of the Invention

The present invention relates to a continuous content playback system that makes it possible for the user to switch from a mobile terminal to anon-portable content playback device, for example, to make it possible for the user to continuously view and listen to certain content.

2. Description of Related Art

In recent years, portable content playback terminals which include a mass storage media, such as a hard disk drive, to store digital content, such as images, audio data, and still pictures, in this storage medium, and which can play back digital content with high definition and high-quality sound have been becoming commonplace.

The user can enjoy content away from home using such a portable content playback terminal, as in a case where the user uses a home AV device at home. However, when the user comes home after he or she has been viewing and listening to certain content outdoors using a portable content playback terminal, the user himself or herself needs to re-specify the content and a playback position of the content in order to continuously view and listen to the rest of the content using a home AV device.

A technology as disclosed by patent reference 1 is proposed to solve this problem. This technology provides a method of switching from a mobile TV equipped with a built-in recorder to a home TV equipped with a built-in recorder so as to make it possible for the user to continuously view and listen to certain content which he or she has been viewing and listening to since before coming home. In other words, when the user connects the mobile TV which he or she has been using outdoors to a home TV, the mobile TV transmits information for specifying the content which the user has been viewing and listening to, and playback location information (i.e., information specifying how far the user has viewed and listened to the program) to the home TV. The home TV then checks to see whether or not the program is stored in the recorder included in the home TV, and, when determining that the program is stored in the recorder, starts playing back the content from a location specified by the playback location information provided from the mobile TV. In contrast, when determining that the program is not stored in the recorder, the mobile TV transfers the content from the recorder included in the mobile TV to the home TV, and the home TV starts playing back the content from a location specified by the playback location information.

[Patent Reference 1] JP,2004-48132,A

A problem with the above-mentioned related art system is, however, that when the desired content are not recorded in the recorder included in the home TV, since the mobile TV promptly transfers the desired content from the recorder included in the mobile TV to the home TV, the user cannot but view and listen to images of the content which are generally coded at a rate of high compression intended for the mobile TV and which are inferior in quality with a relatively large screen of the home TV. Furthermore, the mobile TV typically runs from a battery. Therefore, when the user brings the mobile TV to his or her friend's house, for example, the mobile TV easily consumes the battery to transfer the content to a home TV since there is no corresponding AC/DC adaptor in his or her friend's house in many cases, generally, and this results in a possibility that the battery is totally exhausted and the transfer of the content is aborted.

### SUMMARY OF THE INVENTION

The present invention is made in order to solve the above-mentioned problems, and it is therefore an object of the present invention to provide a continuous content playback system which easily makes it possible for the user to switch from a mobile terminal to another content playback device to continuously view and listen to certain content.

A continuous content playback system in accordance with the present invention includes a content server for storing content; a content playback terminal for playing back content stored in said content server; a mobile terminal for holding identification information indicating specific content which a user has been viewing and listening to, and a playback position of the specific content, for, when receiving an instruction for continuous playback of the specific content, acquiring the storage location of the specific content in the content server based on the held identification information indicating the specific content, and notifying this storage location to the content playback terminal, and for specifying a playback starting position based on the held playback position to provide an instruction for continuous playback of the specific content. When receiving the instruction for continuous playback from the mobile terminal, the content playback terminal reads the specific content from the storage location in the content server and carries out a continuous playback of the specific content from the playback starting position according to the instruction.

As previously mentioned, when the continuous content playback system of the present invention holds the identification information about and playback position of the specific content which the user has been viewing and listening to with the mobile terminal and then carries out a continuous playback of the specific content, the mobile terminal notifies the storage location of the specific content in the content server to the content playback terminal, and the content playback terminal reads the specific content from the storage location in the content server and carries out a continuous playback of the specific content from the playback starting position according to the instruction. Therefore, the continuous content playback system easily makes it possible for the user to switch from the mobile terminal to the other content playback device to continuously view and listen to the certain content.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing a continuous content playback system according to embodiment 1 of the present invention;

FIG. 2 is a block diagram of a mobile terminal according to embodiment 1 of the present invention;

FIG. 3 is a block diagram of a content server terminal according to embodiment 1 of the present invention;

FIG. 4 is a block diagram of a content playback terminal according to embodiment 1 of the present invention;

FIG. 5 is a sequence diagram showing the operation of the continuous content playback system according to embodiment 1 of the present invention;

FIG. 6 is an explanatory diagram of terminal information in the continuous content playback system according to embodiment 1 of the present invention;

FIG. 7 is a flow chart showing continuous playback content determination processing carried out by the continuous content playback system according to embodiment 1 of the present invention;

FIG. 8 is a sequence diagram of content metadata searching processing carried out by the continuous content playback system according to embodiment 1 of the present invention;

FIG. 9 is a block diagram of a continuous content playback system according to embodiment 2 of the present invention;

FIG. 10 is a block diagram of a content playback server terminal according to embodiment 2 of the present invention;

FIG. 11 is an explanatory diagram of terminal information in the continuous content playback system according to embodiment 2 of the present invention;

FIG. 12 is a block diagram of a mobile terminal according to embodiment 3 of the present invention;

FIG. 13 is a sequence diagram showing the operation of the continuous content playback system according to embodiment 3 of the present invention;

FIG. 14 is a flow chart showing specific terminal retrieval processing carried out by the continuous content playback system according to embodiment 3 of the present invention;

FIG. 15 is a block diagram of a mobile terminal in a continuous content playback system according to embodiment 4 of the present invention;

FIG. 16 is an explanatory diagram of a content playback conditions table in the continuous content playback system according to embodiment 4 of the present invention;

FIG. 17 is an explanatory diagram showing a screen display example provided by a user interface in the continuous content playback system according to embodiment 4 of the present invention;

FIG. 18 is a flow chart showing the operation of the continuous content playback system according to embodiment 4 of the present invention;

FIG. 19 is an explanatory diagram showing a screen display example provided by the user interface in the continuous content playback system according to embodiment 4 of the present invention;

FIG. 20 is a block diagram of a continuous content playback system according to embodiment 5 of the present invention;

FIG. 21 is a block diagram of a mobile terminal in the continuous content playback system according to embodiment 5 of the present invention;

FIG. 22 is a flow chart showing the operation of the continuous content playback system according to embodiment 5 of the present invention;

FIG. 23 is an explanatory diagram showing a screen display example provided by a user interface in the continuous content playback system according to embodiment 5 of the present invention;

FIG. 24 is a block diagram of a mobile terminal in a continuous content playback system according to embodiment 6 of the present invention;

FIG. 25 is an explanatory diagram showing a screen display example provided by a user interface for registration to a play list in the continuous content playback system according to embodiment 6 of the present invention;

FIG. 26 is an explanatory diagram showing an example of the registration to the play list in the continuous content playback system according to embodiment 6 of the present invention; and

FIG. 27 is a sequence diagram showing the operation of the continuous content playback system according to embodiment 6 of the present invention.

### DETAILED DESCRIPTION OF THE PREFERRED EMBODIMENTS

### Embodiment 1

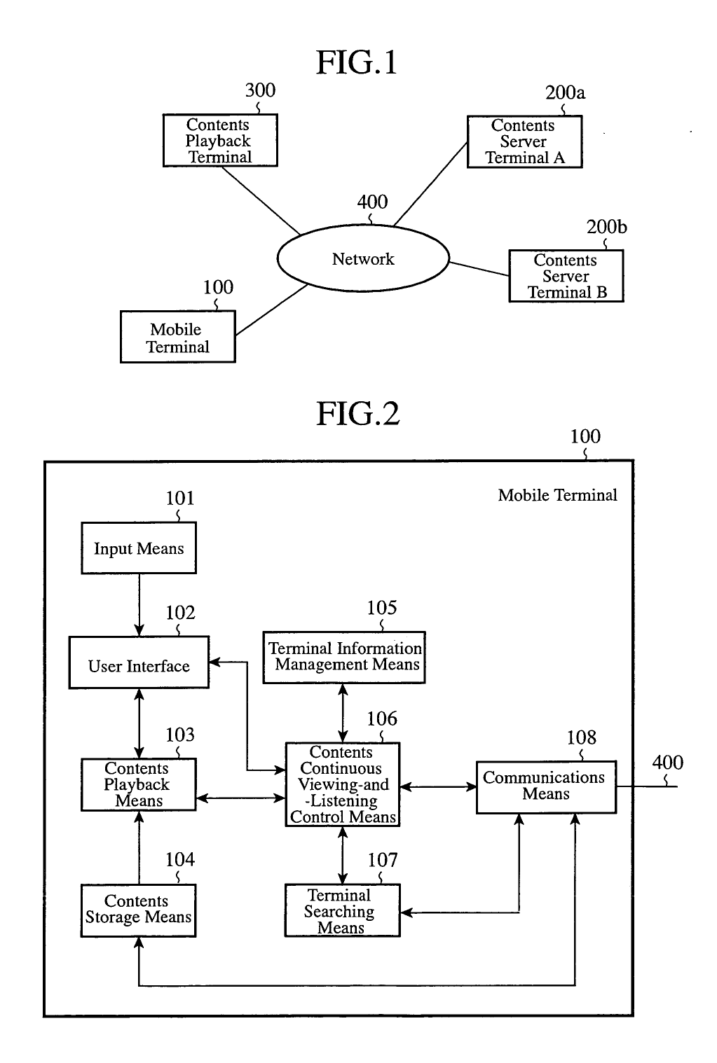

FIG. 1 is a block diagram showing a continuous content playback system according to embodiment 1 of the present invention. As shown in the figure, the continuous content playback system is provided with a mobile terminal 100, a content server terminal A 200a, a content server terminal B 200b, a content playback terminal 300, and a network 400. The mobile terminal 100 is provided with a recorder for recording content therein. The user can carry the mobile terminal 100 with him or her while on the go outdoors, and can cause it to play back content, such as audio, image, or photograph data. Each of the content server terminals A and B (200a and 200b) is a server terminal, such as a NAS (Network Attached Storage), having no function of playing back content, but having a function of storing and transferring content. Hereafter, the content server terminals A and B (200a and 200b) will be explained in common as a content server terminal 200. The content playback terminal 300 is a playback device for playing back content, which does not have any function of storing and transferring content, but having a function of playing back content which it has acquired from a content server terminal 200 via the network 400. The network 400 provides a communication path for enabling the mobile terminal 100, each content server terminal 200, and the content playback terminal 300 to communicate with one another.

FIG. 2 is a block diagram of the mobile terminal 100. The mobile terminal 100 is provided with an input means 101, a user interface 102, a content playback means 103, a content storage means 104, a terminal information management means 105, a content continuous playback control means 106, a terminal searching means 107, and a communications means 108, as shown in the figure.

The input means 101 receives an input from the user and interprets this input as a key event. The user interface 102 receives the key event output from the input means 101, and provides a required instruction for the content playback means 103 and content continuous playback control means 106. The content playback means 103 acquires content, such as image, audio, or photograph data, from the content storage means 104, and then decodes and displays the content. The content storage means 104 acquires content by way of either the network 400 or a not shown flash memory terminal, and then stores them, as well as metadata corresponding to the content, therein. The terminal information management means 105 registers the content playback terminal 300 which takes over the playback of content, and each content server terminal 200 which acquires content therein. The content continuous playback control means 106 plays a key role when the mobile terminal 100 carries out continuous playback processing, and has the following functions.

Receive a user input from the user interface 102, and start processing for continuous playback.

Acquire both an identifier (i.e. identification information) identifying the content which the user has been viewing and listening to and a playback position from the content playback means 103.

Carry out searching of the content, and playback control of the content using a service provided by a terminal stored in the terminal information management means 105.

The terminal searching means 107 searches for a certain terminal on the network 400 through the communications means 108, and the communications means 108 serves as an interface when the mobile terminal 100 is connected to the network 400.

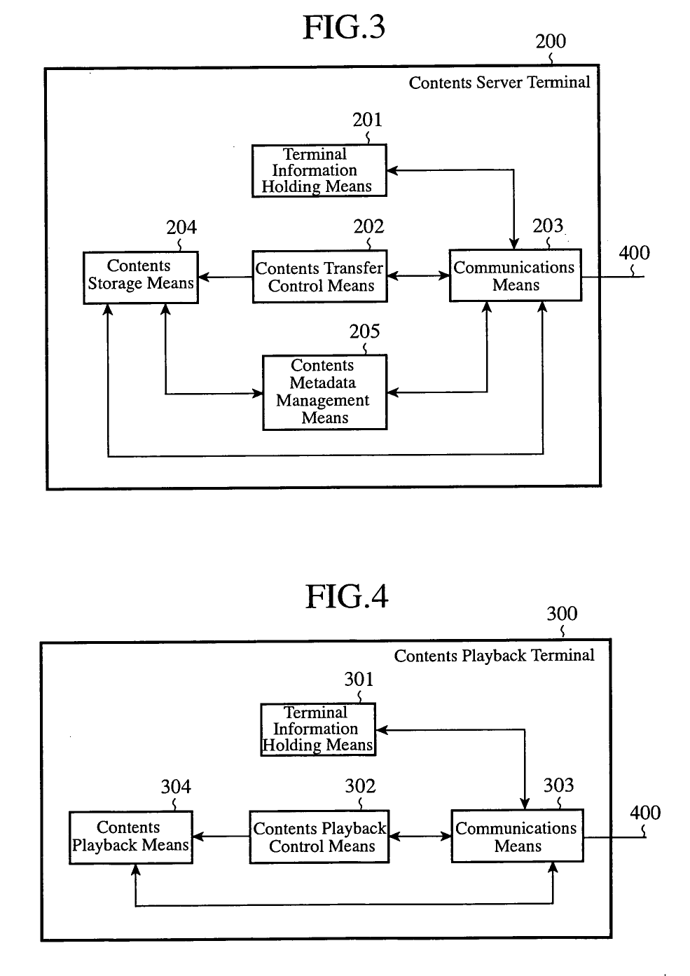

FIG. 3 is a block diagram of each content server terminal 200. Each content server terminal 200 is provided with a terminal information holding means 201, a content transfer control means 202, a communications means 203, a content storage means 204, and a content metadata management means 205, as shown in the figure.

The terminal information holding means 201 holds, as terminal information, metadata, such as the name of the corresponding content server terminal 200, an identifier for making it possible to uniquely identify the corresponding content server terminal 200 on the network 400, the type of each content server terminal, services which the corresponding content server terminal provides to outside the corresponding content server terminal, and the manufacturer of the corresponding content server terminal. The content transfer control means 202 carries out transfer control of content in response to a request for transfer of the content from the content playback terminal 300. The communications means 203 serves as an interface when the corresponding content server terminal 200 is connected to the network 400. The content storage means 204 acquires content from another content server terminal 200 on the network 400, a not shown flash memory interface or the like via the communications means 203, and the stores the acquired content therein. The content metadata management means 205 holds and manages content metadata, such as the title, description, and creation date of each content stored in the content storage means 204, and retrieves metadata about content based on a provided identifier identifying the content.

FIG. 4 is a block diagram of the content playback terminal 300. The content playback terminal 300 is provided with a terminal information holding means 301, a content playback control means 302, a communications means 303, and a content playback means 304, as shown in the figure. The terminal information holding means 301 holds, as terminal information, metadata, such as the name of the content playback terminal 300, an identifier for making it possible to uniquely identify the content playback terminal 300 on the network 400, the type of the content playback terminal 300, and the manufacturer of the content playback terminal 300. The content playback control means 302 receives a content playback control command from the mobile terminal 100, and then provides a required instruction for a corresponding content server terminal 200. The communications means 303 serves as an interface when the content playback terminal 300 is connected to the network 400. The content playback means 304 plays back and displays content which the content playback terminal has acquired from a specific content server terminal 200 on the network 400 by way of the communications means 303.

Next, how the mobile terminal 100, each content server terminal 200, and the content playback terminal 300 which are disclosed in embodiment 1 switch from the mobile terminal 100 to the content playback terminal 300 for a continuous playback of specific content in cooperation with one another will be explained.

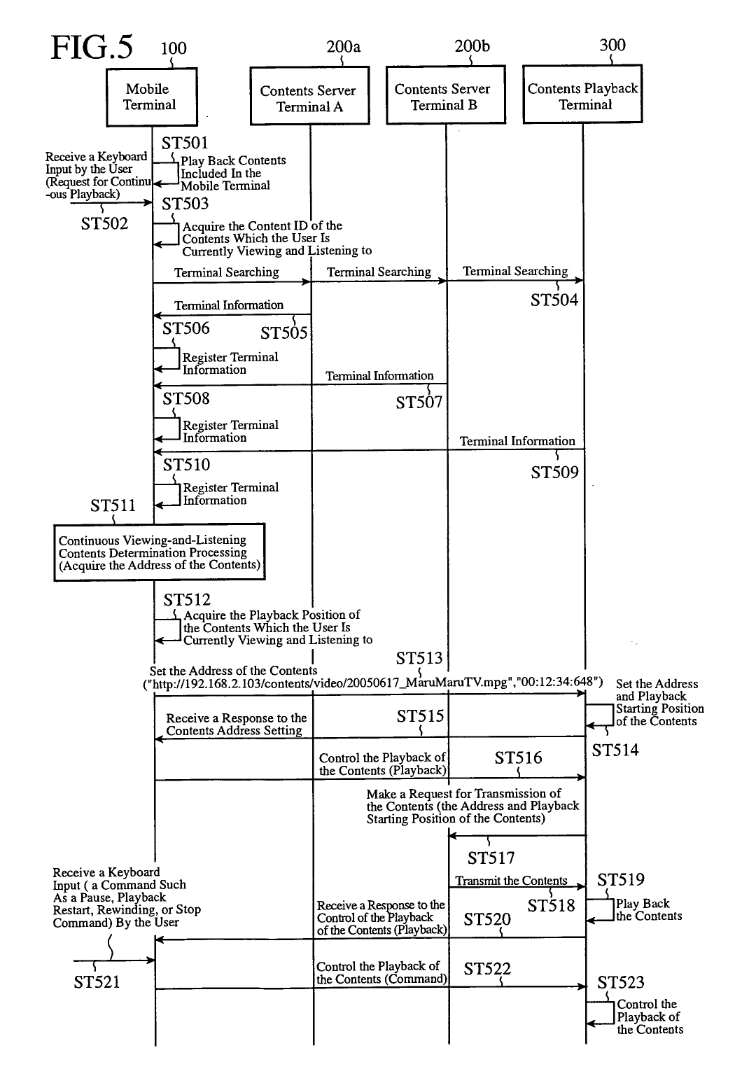

FIG. 5 is a sequence diagram showing the operation of the continuous content playback system according to embodiment 1. Assume that, as shown in FIG. 1, the single mobile terminal 100, two content server terminals 200 (the content server terminal A 200a and content server terminal B 200b) and single content playback terminal 300 are connected to the network 400.

First, assume that the user is viewing and listening to specific content recorded in the mobile terminal 100 away from home (in step ST501). When the user then comes home, he or she can make a request of the mobile terminal 100 for a continuous playback of the content in order to cause the content playback terminal 300 at home to continuously play back the content which he or she is currently viewing and listening to with the mobile terminal 100 by pushing a specific button of the input means 101 included in the mobile terminal 100, for example (in step ST502). The content continuous playback control means 106 receives the continuous playback request from the user interface 102, and then acquires the content ID of the content currently being played back at this time from the content playback means 103 (in step ST503). The content ID is information for identifying the content, and a combination of following pieces of information can be used, as the content ID, according to the type of the content, such as image, audio, or photograph data. If an ID which is unique in the world irrespective of the type of the content can be assigned to the content, it can be used instead.

Image Content

Title, creator, performer, director, creation date, creation country, playback time, genre, description, coding method, and coding rate

Channel, broadcasting station name, recording start time, record time, broadcast date, and air time (in a case of broadcast content, such as a TV program)

Audio Content

Title, creator, album name, player, composer, songwriter, creation date, creation country, playback time, genre, description, coding method, coding rate, and sampled and coded melody information

Frequency, broadcasting station name, broadcast date, and air time (in a case of broadcast content, such as a radio program)

Photograph Content

Title, creator, photographer, creation date, camera, location, coding method, and coding rate

The content continuous playback control means 106 included in the mobile terminal 100 then makes a terminal searching request of the terminal searching means 107 so as to search for a terminal (i.e., a content server terminal 200 or the content playback terminal 300) which exists on the network 400. The terminal searching means 107 carries out terminal searching by way of the communications means 108 (in step ST504) It is assumed that the terminal searching means 107 carries out the terminal searching using, for example, a multicast method of transmitting packets to a specific group on the network 400 all at once. Therefore, the terminal searching means 107 has only to issue a searching request to a specific address on the network 400 only once.

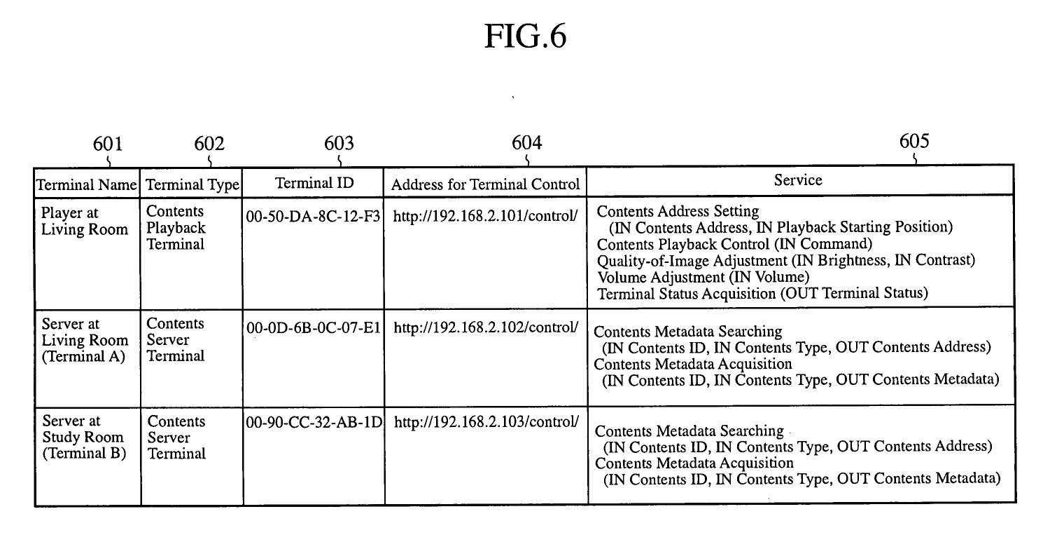

When the mobile terminal 100 carries out the terminal searching, each terminal on the network sends back terminal information which is meta data about each terminal to the mobile terminal 100 (e.g., each content server terminal 200 sends back the terminal information stored in the terminal information holding means 201 thereof to the mobile terminal 100, and the content playback terminal 300 sends back the terminal information stored in the terminal information holding means 301 thereof to the mobile terminal 100). The terminal searching means 107 included in the mobile terminal 100 delivers each received terminal information to the content continuous playback control means 106, and the content continuous playback control means 106 extracts required information out of each received terminal information, and stores the extracted information, as shown in FIG. 6, in the terminal information management means 105 (in steps ST504 to ST510).

FIG. 6 shows each terminal information which is managed by the terminal information management means 105, and which includes fields such as a terminal name field 601, a terminal type field 602, a terminal ID field 603, an address field 604 for terminal control, and a service field 605. The terminal name field 601 includes information indicating the name of a corresponding terminal, and the terminal type field 602 includes information indicating whether the corresponding terminal is a content server terminal 200 or the content playback terminal 300. The terminal ID field 603 includes terminal identification information for identifying the corresponding terminal, the address field 604 for terminal control includes an address used for controlling the corresponding terminal, and the service field 605 includes information about services provided by the corresponding terminal.

In the example of FIG. 6, the terminal identification information included in the terminal ID field 603 shows a terminal ID in a case where the network 400 is an Ethernet (registered trademark) one, and a MAC (Media Access Control) address peculiar to the network interface card of each terminal is used as the terminal ID. The address field 604 for terminal control shows an address in a case where each terminal is controlled according to HTTP (HyperText Transfer Protocol). The mobile terminal 100 can use any service indicated by the service field 605, and, when using a service, transmits an HTTP message in which an appropriate parameter is set to the name of the service provided by the service field 605 to the address specified by the address field 604 for terminal control. In each of two or more services described by the service field 605, parameters are separated by commas and listed in a parenthesis located behind each service's name, and a parameter for input is described as IN and a parameter for output is described as OUT. When using a service, the mobile terminal sets a desired parameter to IN and obtains an output described as OUT as a response provided by the service.

In the service field 605, as the services provided by the content playback terminal 300, 1) content address setting service, 2) content playback control service, 3) quality-of-image adjustment service, 4) volume adjustment service, and 5) terminal status acquisition service are provided.

The above-mentioned 1) content address setting service is the one for setting both an address indicating the location of content acquired by the mobile terminal 100, and a playback starting position to the player. The player does not immediately start the playback of the content only by using this content address setting service, and has to carry out the 2) content playback control to actually playback the content. The 2) content playback control service provides a function of actually executing a command, such as a playback, pause, playback restart, fast forward, rewinding, or stop command, to control the playback of the content which is specified by the 1) content address setting service. The user can directly cause the mobile terminal 10 to carry out the playback control through the input means 101, user interface 102, content continuous playback control means 106, and communications means 108 of the mobile terminal 100. The 3) quality-of-image adjustment and 4) volume adjustment services are also the ones which make it possible for the user to directly cause the mobile terminal 10 to carry out quality-of-image adjustment and volume adjustment, respectively, through the input means 101, content continuous playback control means 106, and so on of the mobile terminal 100. The 5) terminal status acquisition service is the one for acquiring the status of the content playback terminal 300, and can provide information, including the playback state of the content (e.g., under playback or pause), and the title, type, address, playback time and location, brightness, contrast, volume, etc. of the content currently being played back.

On the other hand, as the services by each content server terminal 200, content metadata searching and content metadata acquisition services are provided. The content metadata searching service is the one for specifying a content ID as a search key, searching through each content server terminal 200 for content metadata which matches the conditions specified by the content ID, and for, when finding out content metadata which matches the conditions specified by the content ID, providing an address specifying the content, as an output, for a terminal which has called the service. The content metadata acquisition service is the one for outputting metadata about all content specified by a content type indicating the type of content, such as image, music, or photograph data without carrying out searching for content.

When detecting that two or more content playback terminals 300 exist on the network 400, the user interface 102 of the mobile terminal 100 can urge the user to select one of the two or more content playback terminals 300 so as to continuously view and listen specific content. As an alternative, the mobile terminal can register the terminal ID of a certain content playback terminal 300 into the terminal information management means 105 in advance, and can use the certain content playback terminal 300 as a predetermined terminal. The user interface 102 of the mobile terminal can alternatively urge the user to select one of the two or more content playback terminals 300 when any predetermined content playback terminal 300 which is registered into the terminal information management means 105 in advance is not found out. In addition, a predetermined content playback terminal 300 can be assigned to each of all types of content, such as image, music, and photograph content.

The mobile terminal 100 can further acquire information indicating the status of a content playback terminal 300 specified by using one of the above-mentioned methods through the terminal status acquisition service provided by the content playback terminal 300 from this content playback terminal 300, and can provide the user interface 102 included in the mobile terminal 100 with the following acknowledgement message according to the status of the content playback terminal 300.

[Examples of the Acknowledgement Message Provided to the User]

The specified device is playing back video content. Do you want interruption and continuous playback of the video which you are viewing and listening to now?

It is a midnight time now. Do you want continuous playback of music which you are listening to now using the specified device?

When the user selects “don't want” to the above-mentioned acknowledgement message, the continuous playback processing flow shown in FIG. 5 is stopped at this time.

Next, in performing the playback content determination processing, the content continuous playback control means 106 of the mobile terminal 100, in step ST511 shown in FIG. 5, specifies content which are determined to be the same as those specified by the content ID acquired in step ST503, and acquires an address for making it possible to uniquely identify the content on the network 400. For example, a URL (Uniform Resource Locator) or the like can be used as the address. The details of this continuous playback content determination processing will be explained below.

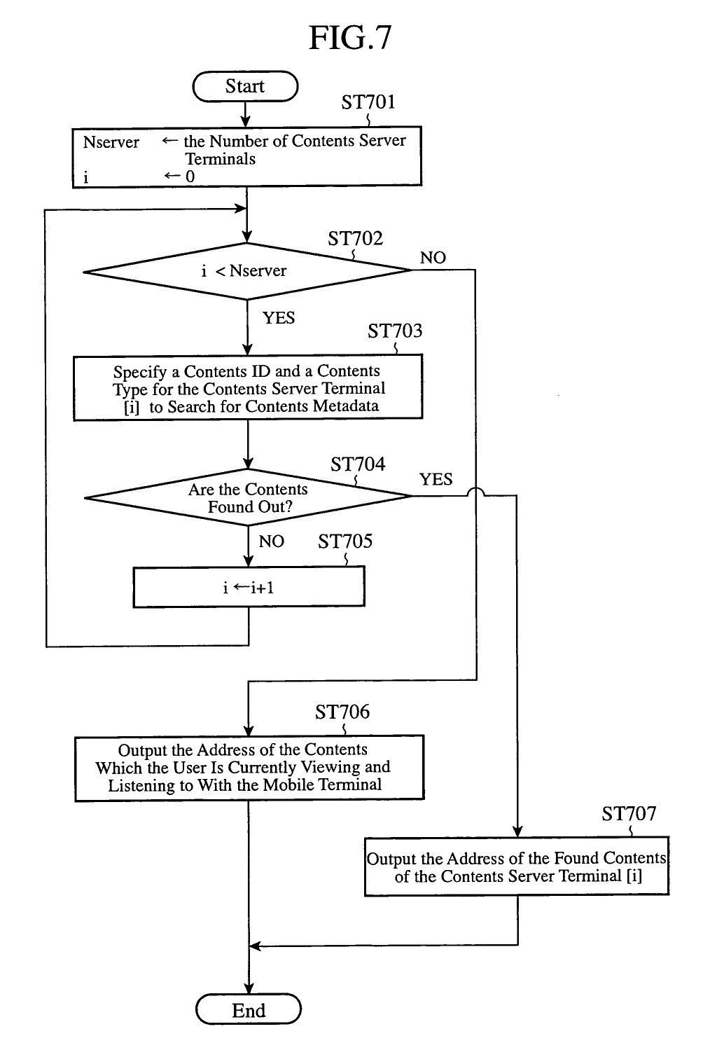

FIG. 7 is a flow chart showing the continuous playback content determination processing. The content continuous playback control means stores the total number of content server terminals 200 which are found out in steps ST504 to ST510 in a variable Nserver first. In other words, the content continuous playback control means 106 determines the variable Nserver by acquiring the number of terminals whose terminal type field 602 indicates that it is a content server terminal 200 from among the plural pieces of terminal information managed by the terminal information management means 105. The content continuous playback control means then substitutes 0 into i which is used as an index for loop processing (in step ST701) The content continuous playback control means further determines whether or not i indicates that the processing is completed for all content server terminals according to the following inequality (in step ST702).

I<Nserver

While the above-mentioned inequality is satisfied, the content continuous playback control means advances the processing to step ST703. When the above-mentioned inequality becomes unsatisfied, the content continuous playback control means advances the processing to step ST706 in which it outputs the address of the content which the user is currently viewing and listening to now with the mobile terminal 100, and ends the processing. When advancing the processing to step ST703, the content continuous playback control means specifies the content ID for a content server terminal [i] which is the i-th content server terminal 200 managed by the terminal information management means 105 so as to search for content metadata. The content metadata searching processing will be explained below.

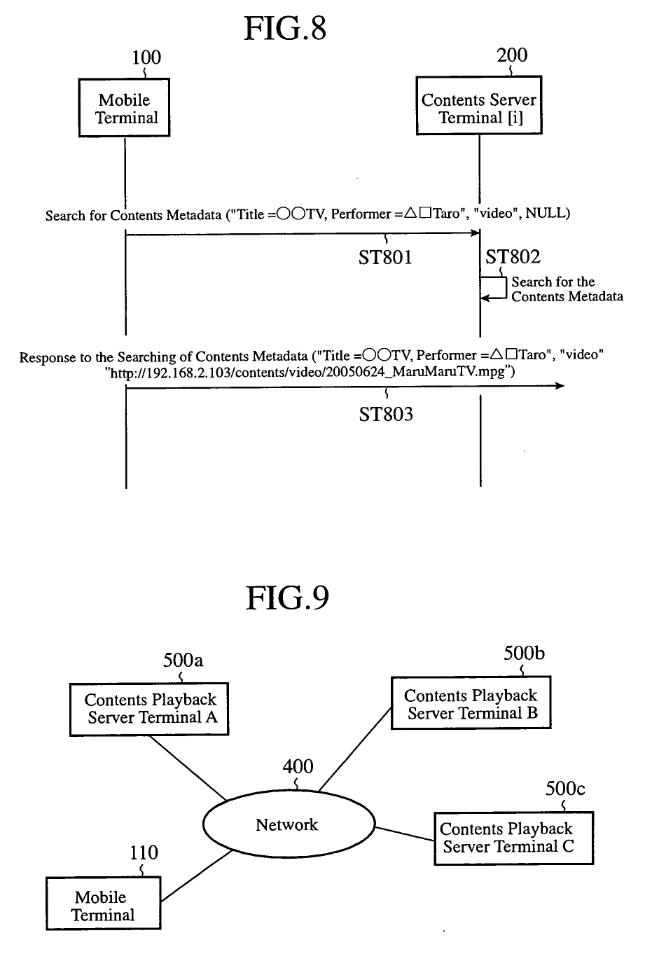

FIG. 8 shows the sequence of the content metadata searching processing. The content continuous playback control means 106 included in the mobile terminal 100 searches for metadata about the content by using a content metadata searching service among the services, as shown in FIG. 6, which are provided a content server terminal 200 managed by the terminal information management means 105 (in step ST801). In the example shown in step ST801, “title=◯◯TV and performer=Δ□taro” are specified as the content ID which is a key for the content searching. In this case, NULL is specified, as a content address which is an output of the content metadata searching processing, in order to specify that it is a request for content metadata searching.

As the content ID, information indicating conditions restricting content, such as “coding method=MPEG-2 and coding rate>8 Mbps” showing that the coding method is an MPEG (Moving Picture Expert Group)-2 method, and the coding rate is 8 or more Mbps, can be provided to specify content. As an alternative, when recorded broadcast content or the like are a target for the content metadata searching, a time when the recording was started and the length of time period over which the broadcast content were recorded, such as “recording start time=Jun. 29, 2005 22:00:00, and record time=30:00:00”, can be specified as the content ID. When a recording start time and a record time are specified, the content server terminal 200 which searches for metadata can provide, as searching results, content which satisfy conditions which are close to these conditions as much as possible on a priority basis even though no content which strictly satisfy the conditions exist.

The content server terminal 200 which has received a request for provision of a service from the mobile terminal 100 refers to the provided content ID, and searches through the metadata managed by the content metadata management means 205 for content which satisfy the conditions (in step ST802) In this example, the content server terminal determines that metadata about single content satisfy the conditions, and then transmits the address of the content to the mobile terminal 100 as a response of the content metadata searching service (in step ST803). In this example, only the address of the content is provided, as a response of the content metadata searching service, for the mobile terminal. As an alternative, metadata, such as the titles of two or more contents which satisfy the conditions, and performers, or the addresses of the two or more contents can be transmitted to the mobile terminal.

As mentioned above, the content continuous playback control means, in step ST703, searches for content metadata. When a value is set to the content address in the response of the content metadata searching, as shown in step ST803, the content continuous playback control means determines that the content have been found out in step ST704, and then advances to step ST707. On the other hand, if no value is set to the content address in the response to the content metadata searching, the content continuous playback control means determines that no content which match with the content ID exist, and advances to step ST705.

When finding out the content and then advancing to step ST707, the content continuous playback control means outputs the content address of the found content and ends the processing. On the other hand, when no content have been found out yet, the content continuous playback control means advances to step ST705, and adds 1 to the index i in order to search for content metadata which is stored in the next content server terminal 200.

The continuous playback content determination processing corresponding to step ST511 of FIG. 5 is thus completed. In the example shown in FIG. 5, for the sake of simplicity, it is assumed that content stored in the content server terminal B 200b are determined, in step ST511, as content which are a target for continuous playback. The continuous playback control means 106 included in the mobile terminal 100 then acquires the playback position of the content currently being played back from the content playback means 103 (in step ST512), and makes a request of the content playback terminal 300 for a content address setting service using the acquired content address and playback position (in step ST513).

As the playback position, the continuous playback control means can use a relative playback position relative to the playback time of the content. When the content which the user is currently viewing and listening to are recorded broadcast content, the continuous playback control means can specify an absolute time when the content were broadcast, such as “14:20:00 on Jun. 29, 2005”.

The content playback terminal 300 which has received the request for a content address setting service defines, as parameters, both a content address which is provided in advance within the terminal, and a playback starting position (in step ST514), and sends a response of the content address setting service indicating that the setup of these parameters is normally completed to the mobile terminal 100 (in step ST515).

The continuous playback control means 106 included in the mobile terminal 100 which has received the content address setting response determines that the specified content address and playback starting position have been set to the content playback terminal 300, and makes a request of the content playback terminal 300 for playback of the content through a content playback control service (in step ST516). The content playback terminal 300 which has received the content playback control request determines that a partner of whom it makes a request for playback of the content is the content server terminal B 200b from the content address set in step ST514, and specifies the playback starting position similarly set in step ST514 and makes a request of the content server terminal B 200b for transmission of the content (in step ST517). There is no necessity to use the playback starting position just as it is, and the head of the content can be alternatively specified as the playback starting position.

The content server terminal B 200b provides the content which are specified by the content address and which start from the specified playback starting position for the content playback terminal 300 (in step ST518). The content playback terminal 300 which has acquired the actual content starts playing back the content (in step ST519), and notifies the fact that it has started playing back the content, as a content playback control response, to the mobile terminal 100. At this time, since it is expected that the mobile terminal 100 and content playback terminal 300 play back the same position of the same content, the mobile terminal 100 can automatically stop playing back the content.

When the content playback terminal 300 starts a continuous playback of the content, the content continuous playback control means 106 of the mobile terminal 100 receives, via the user interface 102, an input command about the playback control of the content, which is inputted by the user, such as a pause, playback restart, fast forward, rewinding, or stop command, from the input means 101 (in step ST521), converts the input into a command which can be handled by the content playback control service provided by the content playback terminal 300, and transmits the command, as playback control information about the content, to the content playback terminal 300 (in step ST522). The content playback terminal 300 which has received the playback control information about the content acquires the command which has been transmitted thereto as parameters, and carries out appropriate content playback control (in step ST523).

As mentioned above, the continuous content playback system according to embodiment 1 is provided with the content server for storing content, the content playback terminal for playing back content stored in the content server, the mobile terminal for holding identification information indicating specific content which the user has been viewing or listening to, and a playback position of the specific content, for, when receiving an instruction for a continuous playback of the specific content, acquiring a storage location of the specific content in the content server based on the held identification information indicating the specific content, and notifying this storage location to the content playback terminal, and for specifying a playback starting position based on the held playback position to provide an instruction for a continuous playback of the specific content, and, when receiving the instruction of a continuous playback of the specific content from the mobile terminal, the content playback terminal receives the specific content from the corresponding storage location in the content server and carries out a continuous playback of the specific content from the playback starting position according to the instruction. Therefore, the continuous content playback system can search through two or more content server terminals which exist on the network for specific content which the user is currently viewing and listening to with the mobile terminal, and makes it possible for the user to view and listen to the specific content continuously with a desired content playback terminal, for example.

In addition, in the continuous content playback system according to embodiment 1, the mobile terminal is provided with the content storage means for storing content, and the content playback means for playing back content stored in the content storage means, and holds both identification information indicating content which have been played back by the content playback means, and the playback position of the content. Therefore, the continuous content playback system makes it possible for the user to easily and continuously view and listen to the content, which the user has been viewing and listening to with the mobile terminal, with the content playback terminal.

Furthermore, in the continuous content playback system according to embodiment 1, the mobile terminal sends out playback control information about the content to the content playback terminal, and the content playback terminal carries out playback control of the content according to the playback control information. Therefore, since the user can use the mobile terminal continuously as a control terminal for the content playback terminal even if the user does not look for an input terminal intended for the content playback terminal, the continuous content playback system makes it possible for the user to switch from the mobile terminal to a domestic content playback terminal more smoothly to continuously view and listen to the content which he or she has been viewing and listening to with the mobile terminal.

### Embodiment 2

FIG. 9 is a block diagram showing a continuous content playback system according to embodiment 2. In the figure, the continuous content playback system is provided with a mobile terminal 110, content playback server terminals A, B and C (500a, 500b, and 500c), and a network 400.

Each of the content playback server terminals A, B, and C (500a, 500b, and 500c) can play back content stored therein, and can play back content acquired from any one of the other content playback server terminals A, B, and C (500a, 500b, and 500c) on the network 400, and can transfer content to any one of the other content playback server terminals A, B, and C (500a, 500b, and 500c) on the network 400. The common structure and operation of each of the content playback server terminals A, B, and C (500a, 500b, and 500c) will be explained hereafter as those of a content playback server terminal 500.

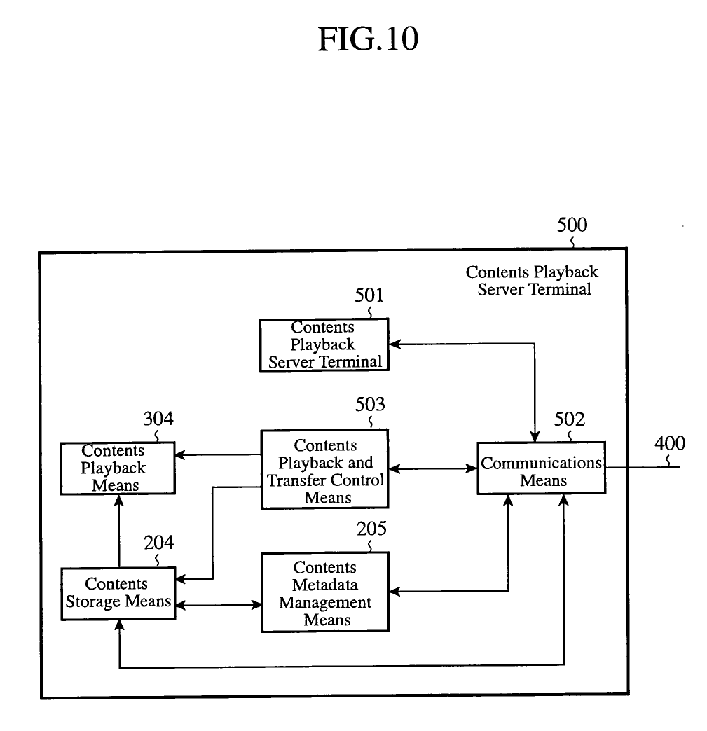

FIG. 10 is a block diagram of the content playback server terminal 500. The content playback server terminal 500 is provided with a content storage means 204, a content metadata management means 205, a content playback means 304, a terminal information holding means 501, a communications means 502, and a content playback and transfer control means 503. The content storage means 204 and content metadata management means 205 have the same functions as the content storage means 204 and content metadata management means 205 of each content server terminal 200 according to embodiment 1, respectively, and the content playback means 304 has the same functions as the content playback means 304 of the content playback terminal 300 according to embodiment 1. Therefore, the explanation of those components will be omitted hereafter.

The terminal information holding means 501 is a functional unit for holding, as terminal information, metadata about the content playback server terminal 500, such as the name of the content playback server terminal 500, an identifier for making it possible to uniquely identify the content playback server terminal 500 on the network 400, the type of the content playback server terminal 500 indicating whether this terminal is a content server terminal, content playback terminal, content playback server terminal, or the like, and the manufacturer of the content playback server terminal 500. The communications means 502 serves as an interface at a time when the content playback server terminal 500 is connected to the network 400. The content playback and transfer control means 503 plays a key role within the content playback server terminal 500, and is so constructed as to carry out control of playback and transfer of content in response to a request from another terminal.

Although the mobile terminal 110 has fundamental functions which are the same as those of the mobile terminal 100 in accordance with embodiment 1, since the content playback server terminal 500 is provided as a terminal for searching for a storage location of specific content, and for providing an instruction for playing back the content, the mobile terminal 110 is constructed as follows. In other words, the mobile terminal 110 is so constructed as to hold identification information indicating specific content which the user has been viewing and listening to and a playback position of the content, and, when receiving an instruction for continuously playing back the specific content from the user, acquire a storage location of the specific content in the content playback server terminal 500 based on the held identification information indicating the specific content, notify this storage location to the content playback server terminal 500 which is to play back the specific content, specify a playback starting position based on the held playback position, and provide an instruction for carrying out a continuous playback of the specific content. The network 400 provides a communication path for enabling the mobile terminal 110 and content playback server terminal 500 to communicate with each other, like that according to embodiment 1.

Next, how the mobile terminal 110 and three content playback server terminals 500 (i.e., the content playback server terminal A 500a, content playback server terminal B 500b, and content playback server terminal C 500c) which are disclosed in embodiment 2 switch from the mobile terminal 110 to one content playback server terminal 500 in cooperation with one another so as to implement a continuous playback of specific content will be explained. Since the fundamental operating sequence of this embodiment is the same as that of embodiment 1, a different operation from that of embodiment 1 will be explained preponderantly with reference to FIG. 5.

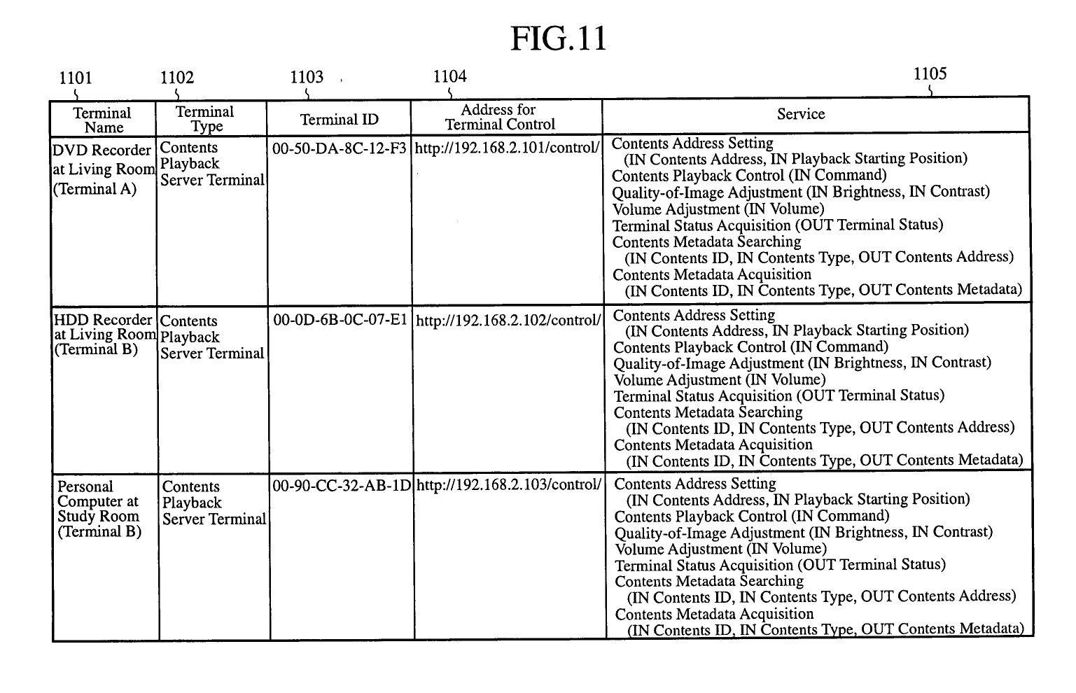

Terminal information about each terminal as shown in FIG. 6 is registered in steps ST504 to ST510 of embodiment 1, as previously mentioned. Also in this embodiment, terminal information about the content playback server terminal 500 as shown in FIG. 11 is similarly registered.

In FIG. 11, each terminal name field 1101 shows the name of a corresponding content playback server terminal 500, each terminal type field 1102 shows the type of the corresponding content playback server terminal 500, each terminal ID field 1103 shows terminal identification information for identifying the corresponding content playback server terminal 500, each address field 1104 for terminal control shows an address for controlling the corresponding content playback server terminal 500, and each service field 1105 shows services provided by the corresponding content playback server terminal 500.

In accordance with this embodiment, the terminal type field 1102 and service field 1105 showing services provided by a corresponding content playback server terminal 500 differ from those of embodiment 1. “Content playback server terminal” is provided as the terminal type field 1102, and the sum of services provided by the content playback terminal and those provided by each content server terminal in accordance with embodiment 1 are provided as the service field 1105. Since each service can be independently used, when desiring to use a content playback function of the content playback server terminal 500, the mobile terminal 110 can use a service (e.g., a content address setting, content playback control, quality-of-image adjustment, or volume adjustment) associated with content playback. Furthermore, when desiring to use a server function of the content playback server terminal 500, the mobile terminal 110 can use both a content metadata searching service and a content metadata acquisition service which are associated with the server function.

In this embodiment, although only three content playback server terminals 500, in addition to the single mobile terminal 110, exist on the network 400, as shown in FIG. 9, a content playback terminal 300 and one or more content server terminals 200 shown in embodiment 1 can be also connected to the network 400. Even if the continuous content playback system is so constructed, the mobile terminal 110 can easily specify a playback terminal which is to continuously play back the specific content, and a server terminal which is to provide the content for the playback terminal from a terminal type and a service which it obtains as terminal information so as to control a continuous playback of the content.

Next, the continuous playback content determination processing carried out in step ST511 of FIG. 5 will be explained with reference to FIG. 7. In step ST701 of embodiment 1, the total number of content server terminals is defined as a variable Nserver. In contrast, in accordance with embodiment 2, the number of content playback server terminals 500 is substituted into the variable Nserver. In an environment where a content playback terminal, one or more content server terminals, and content playback server terminals 500 coexist on the network, the total number of content server terminals and content playback server terminals can be defined as the variable Nserver. Since a process of step ST702 is the same as that of embodiment 1, the explanation of the process will be omitted hereafter.

The mobile terminal then, in step ST703, defines the i-th content playback server terminal managed by the terminal information management means 105 included in the mobile terminal 110 as a content server terminal [i], and specifies a content ID so as to carry out content metadata searching. In accordance with this embodiment, the mobile terminal certainly defines, as a content server terminal [0], a content playback server terminal 500 which is to actually carry out a continuous playback of the specific content, and selects content currently recorded in the content playback server terminal 500 which is to actually play back the content with first priority.

In other words, in accordance with embodiment 2, content which are a target for continuous viewing and listening are determined on the following priority basis (1 has the highest priority).

1. A content playback server terminal which is to carry out a continuous playback of the content

2. Another content playback server terminal connected on the network 400 other than 1.

3. The mobile terminal

Since subsequent processings are the same as those carried out by the mobile terminal, content playback terminal, and content server terminals according to embodiment 1, the explanation of the processings will be omitted hereafter.

As mentioned above, the continuous content playback system according to embodiment 2 includes the content playback server for storing and playing back content, and the mobile terminal for holding identification information indicating specific content which the user has been viewing and listening to, and a playback position of the specific content, for, when receiving an instruction for a continuous playback of the specific content, acquiring a storage location of the specific content in the content playback server based on the held identification information indicating the specific content, and notifying this storage location to the content playback terminal which is to play back the specific content, and for specifying a playback starting position based on the held playback position to provide an instruction for a continuous playback of the specific content, and, when receiving the instruction for a continuous playback of the specific content from the mobile terminal, the content playback terminal receives the specific content from the content playback server having the notified storage location and carries out a continuous playback of the specific content from the playback starting position according to the instruction. The user can continuously view and listen to the content which he or she has been viewing and listening to with the mobile terminal using a predetermined content playback server which is a terminal having a function of playing back content and a function of transferring content to another terminal, as in the case of embodiment 1. Especially, when the terminal which is to play back the specific content and the terminal which transfers the content are the same content playback server, since the content playback server makes it possible for the user to continuously view and listen to the content without transferring the content via the network, no transmission delay due to transfer via the network occurs and therefore the playback, fast forward, rewinding, etc. of the content can be implemented with good response.

### Embodiment 3

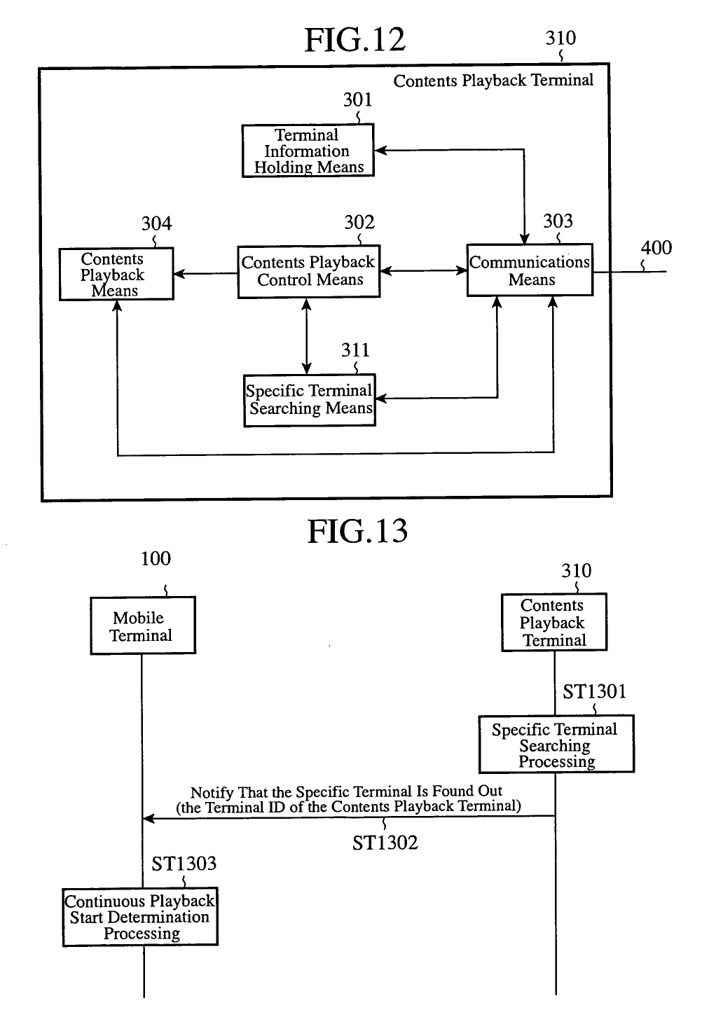

FIG. 12 is a block diagram of a content playback terminal 310 of a continuous content playback system in accordance with embodiment 3. The content playback terminal 310 according to embodiment 3 is provided with a terminal information holding means 301, a content playback control means 302, a communications means 303, a content playback means 304, and a specific terminal searching means 311. Since the terminal information holding means 301, content playback control means 302, communications means 303 have the same structures as those of embodiment 1, the explanation of these components will be omitted hereafter. The specific terminal searching means 311 searches for a specific terminal on a network 400. This specific terminal searching means 311 is so constructed as to hold a terminal ID of a terminal which is a target for searching by the content playback terminal therein, and to search for the specific terminal through the communications means 303 at predetermined intervals. In accordance with embodiment 3, since a mobile terminal 100, a content server terminal 200, and the network 400 have the same structures as those of embodiment 1, respectively, the explanation of these components will be omitted hereafter, and the following explanation of the continuous content playback system will be made with reference to FIG. 1.

The continuous content playback system according to this embodiment advances continuous playback processing automatically even if the user does not make a key input as a cause to continuously view and listen to specific content, as shown in step ST502 of FIG. 5. Next, the operation of the mobile terminal 100 and content playback terminal 310 according to this embodiment will be explained.

FIG. 13 is a sequence diagram showing a process of searching for the mobile terminal 100, and then making a request of the mobile terminal 100 for a continuous playback of specific content when finding out the mobile terminal 100, which is carried out by the content playback terminal 310 according to this embodiment.

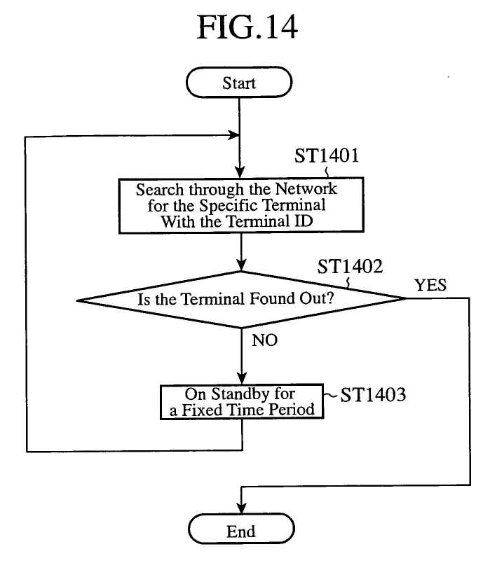

The content playback terminal 310, in step ST1301, carries out a specific terminal searching process of searching for a specific terminal first, and the details of this process will be explained with reference to FIG. 14. In FIG. 14, the specific terminal searching means 311, in step ST1401, searches through the network 400 for a specific terminal which is specified by the communications means 303 based on the terminal ID, and, in step ST1402, determines whether or not the specific terminal exists on the network. When finding out the desired terminal, the specific terminal searching means ends the processing. On the other hand, when not finding out the desired terminal, the specific terminal searching means returns the processing to step ST1401 in which it searches for the specific terminal again after waiting for a fixed time period (in step ST1403).

When finding out the specific terminal and ends the specific terminal searching processing, the content playback terminal 310 then transmits a notification indicating that it has found out the specific terminal, as well as the terminal ID thereof, to the mobile terminal 100 (in step ST1302). The mobile terminal 100 which has received the notification indicating that the content playback terminal 310 has found out the specific terminal determines whether or not to start continuous playback processing (in step ST1303). When the mobile terminal 100 can recognize that the content playback terminal 310 which has transmitted the notification indicating that it has found out the specific terminal is a predetermined terminal which is already registered into the terminal information management means 105 included in the mobile terminal 100 from the received terminal ID of the content playback terminal 310, the mobile terminal 100 determines that the content playback terminal 310 is the terminal which the user usually uses, and starts the continuous playback processing including step ST503 and subsequent steps shown in FIG. 5. On the other hand, when the terminal ID of the content playback terminal 310 is not registered into the terminal information management means 105 included in the mobile terminal 100, the mobile terminal 100 waits for a continuous playback request by the user without starting the continuous playback processing.

Although the above-mentioned explanation is made by taking, as an example, the case where the content playback terminal 310 searches for the mobile terminal 100 periodically, the mobile terminal 100 can similarly search for the content playback terminal 310 periodically. In this case, a content continuous playback control means 106 acquires the terminal ID of the predetermined terminal managed by the terminal information management means 105 included in the mobile terminal 100, and controls the terminal searching means 107 so that it searches for a terminal whose terminal ID matches with the terminal ID at fixed intervals. When finding out a terminal whose terminal ID matches with the terminal ID, the content continuous viewing control means 106 starts the continuous playback processing including step ST503 and subsequent steps shown in FIG. 5 immediately.

As mentioned above, in the continuous content playback system according to embodiment 3, when searching for a mobile terminal which is determined in advance and finding out the mobile terminal, the content playback terminal notifies the fact that the content playback terminal can continuously play back the specific content to the mobile terminal. Therefore, the continuous content playback system can make the user continuously view and listen to the content automatically without manipulating the mobile terminal.

In a case where the mobile terminal has a communications interface such as a wireless LAN, when the user comes home while viewing and listening to specific content with the mobile terminal, the continuous content playback system makes it possible for the content playback terminal to start a continuous playback of the content considerably before the user gets close to the content playback terminal since the distance over which communications can be carried out using such a wireless LAN is of order of some hundreds of meters. In other words, the user can automatically view and listen to the rest of the content without any need to perform any burdensome operation when coming home.

Furthermore, in the continuous content playback system according to embodiment 3, when searching for a content playback terminal which is determined in advance and finding out the content playback terminal, the mobile terminal defines the content playback terminal as a content playback terminal which carries out a continuous playback of the specific content. Therefore, the continuous content playback system can make the user continuously view and listen to the content automatically without manipulating the mobile terminal, as in the case where the content playback terminal searches for a predetermined mobile terminal periodically.

Although above-mentioned embodiment 3 is applied to the structure of embodiment 1, it can be alternatively applied to the structure of embodiment 2. In other words, the specific terminal searching means 311 can be disposed in the content playback server terminal 500 for playing back content, and can be so constructed as to carry out the same specific terminal searching processing as previously mentioned in embodiment 3.

### Embodiment 4

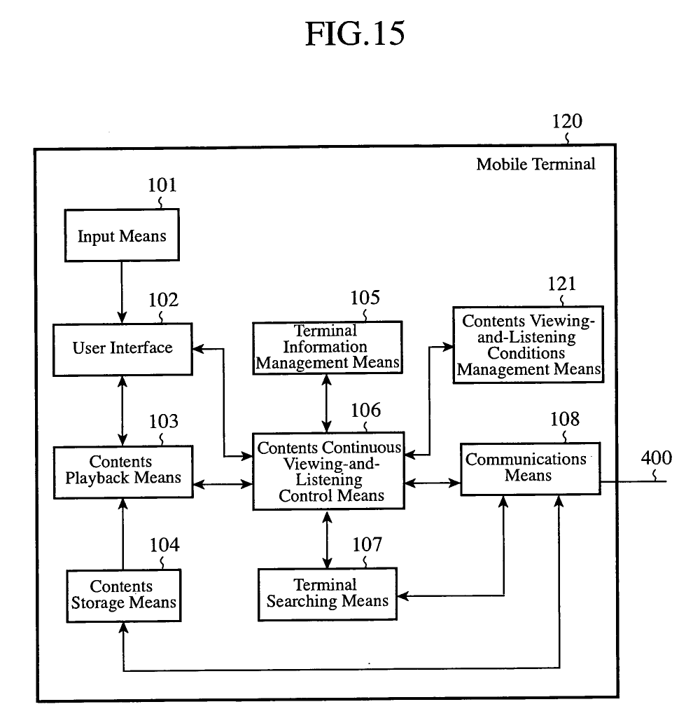

FIG. 15 is a block diagram of a mobile terminal 120 of a continuous content playback system in accordance with embodiment 4. The mobile terminal 120 of embodiment 4 is provided with an input means 101, a user interface 102, a content playback means 103, a content storage means 104, a terminal information management means 105, a content continuous playback control means 106, a terminal searching means 107, a communications means 108, and a content viewing and listening conditions management means 121. Since the input means 101, user interface 102, content playback means 103, content storage means 104, terminal information management means 105, content continuous playback control means 106, terminal searching means 107, and communications means 108 are the same as those of embodiment 1, the explanation of these components will be omitted hereafter.

A content server terminal 200, a content playback terminal 300, and a network 400 of this embodiment have the same structures as those of embodiment 1, respectively.

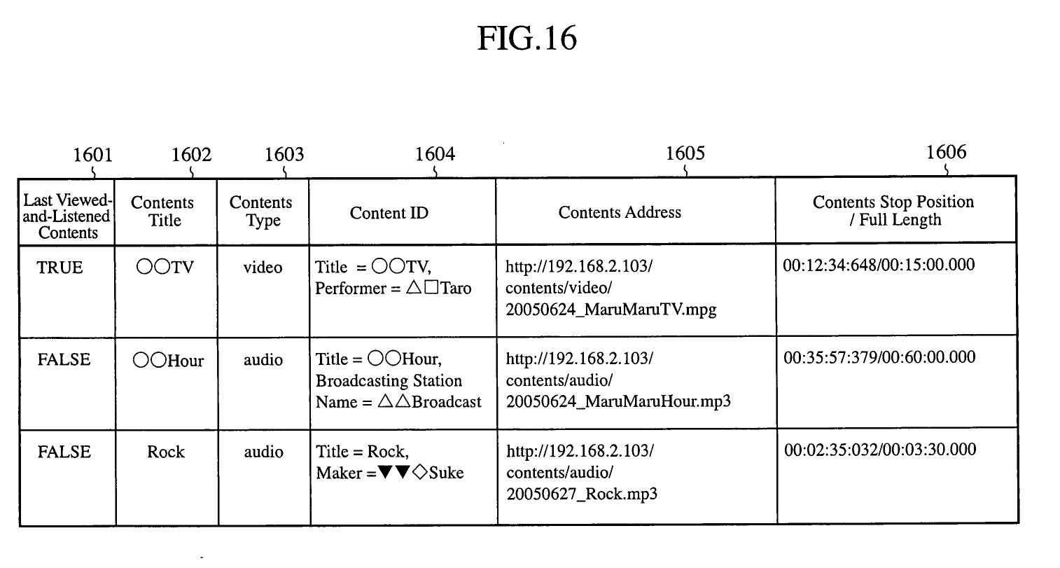

The content viewing and listening conditions management means 121 manages playback conditions for each of two or more contents which the user is viewing and listening to. The content playback conditions management means 121 internally manages playback conditions over each of two or more contents which the user is viewing and listening to using a content playback conditions table as shown in FIG. 16.

As shown in FIG. 16, last playback content information 1601 is set to TRUE when corresponding content are the content which the user has viewed the last time among the two or more contents which the user is viewing and listening to. Title information 1602 indicates the title of the content which the user has viewed the last time. Content type information 1603 indicates the type of the content. Content ID information 1604 identifies the content, and content address information 1605 indicates an address for determining the location on the network 400 where the content are stored. Playback stop position/full length information 1606 indicates how far the user has viewed and listened to the content, and the full length of the content.

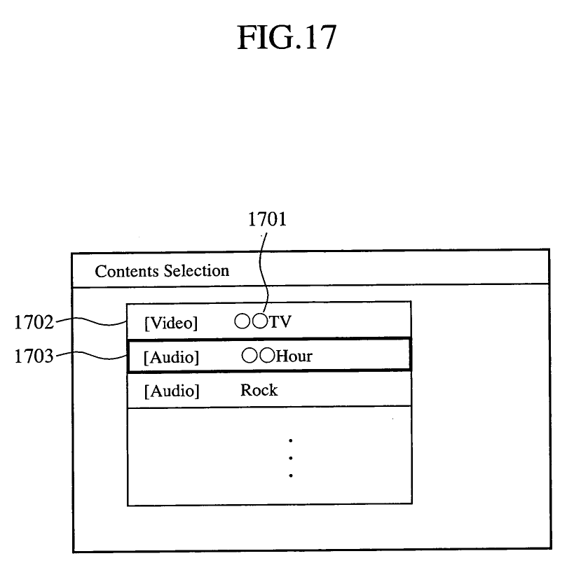

How the content playback conditions table managed by the above-mentioned content playback conditions management means 121 is generated will be explained first. When either of 1) content playback with the mobile terminal and 2) content playback with the content playback terminal is carried out, required information extracted from metadata about the content which the user is viewing and listening to is registered into the content viewing conditions table. The content continuous playback control means 106 can acquire either metadata about content managed by a content server terminal 200 on the network using a content metadata acquisition service provided by the content server terminal 200, or metadata about content stored in the mobile terminal 120, and can generate such a user interface screen display as shown in FIG. 17 on the user interface 102.

In FIG. 17, each title 1701 indicates the title of corresponding content, each type 1702 indicates the type of corresponding content, and a cursor 1703 indicates content which the user is selecting. The user selects content using this user interface screen display, and further selects a content playback terminal from among terminals including the mobile terminal 120 itself using a not shown user interface screen display for content playback terminal selection. The user can thus view and listen to the selected content using a desired terminal. Furthermore, when the user stops viewing and listening to the content or turns off the power, the content playback conditions management means extracts a playback point at which the playback of the content has been stopped and updates the playback stop position 1606 of FIG. 16.

When the user has viewed and listened to 20% or more of the playback time of the selected content, for example, the content playback conditions management means 121 can determine that the user is interested in the content, and register metadata about the content into the content playback conditions table. After registering metadata about the content into the content playback conditions table, the content playback conditions management means 121 can determine that the user has finished viewing and listening to the content, and delete the metadata about the content from the content playback conditions table when no access is made to the content for a certain time period or more or when the user has viewed and listened to 95% or more of the total playback time of the content.

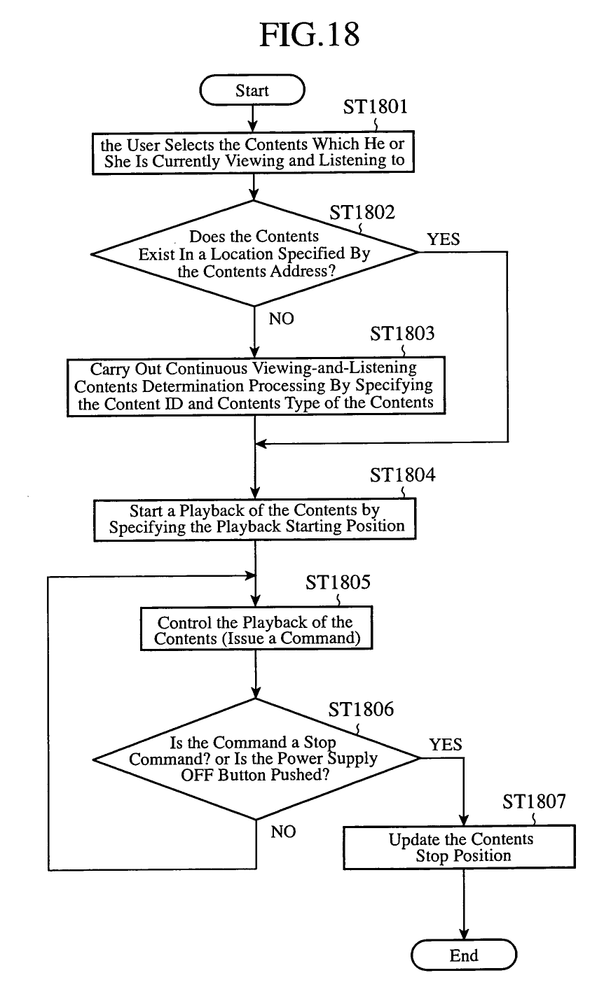

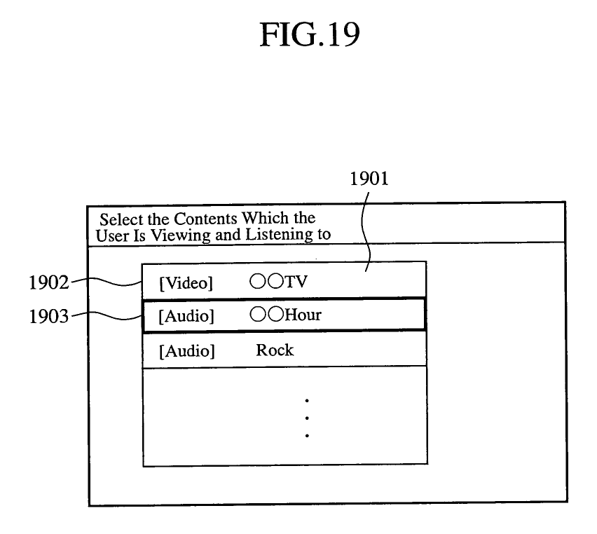

Next, the operation of the mobile terminal 120 in accordance with embodiment 4 will be explained. FIG. 18 is a flow chart showing the operation of the mobile terminal 120. The content continuous playback control means 106 included in the mobile terminal 120 acquires the user's content playback conditions table as shown in FIG. 16 from the content playback conditions management means 121 first, and makes a request of the user interface 102 to generate a user interface screen display as shown in FIG. 19. The user selects content according to the user interface screen display (in step ST1801). In FIG. 19, each title 1901 indicates the title of corresponding content, each type 1902 indicates the type of corresponding content, the information indicated by the corresponding content type field 1603 is used as each type, and a cursor 1903 indicates content which the user is selecting.

The content continuous playback control means 106 acquires information indicating which content the user has selected through the user interface 102, acquires the content address of the content from the content playback conditions table, and checks to see whether the content actually exist in a location specified by the address (in step ST1802). The content continuous playback control means 106 can carry out the checking of whether the content actually exist in the location by transmitting an HTTP request to the content address, and then determining whether or not it has acquired the content actually. When acquiring the content as a response, the content continuous playback control means 106 advances to step ST1804, whereas when not acquiring the content as a response, but receiving an error sent back thereto, it advances to step ST1803.

In step ST1803, the content continuous playback control means 206 specifies the content ID and content type of the content which are registered into the content playback conditions table, carries out continuous playback content determination processing, and acquires the content address of the content (in step ST1803). Since the continuous playback content determination processing of this embodiment is the same as that of embodiment 1, the explanation of the continuous playback content determination processing will be omitted hereafter.

When acquiring the content address, the content continuous playback control means 206 further acquires a playback starting position from the corresponding playback stop position field 1606 included in the content playback conditions table, and starts a playback of the content (in step ST1804). As shown in embodiment 1, the content continuous playback control means 106 carries out and implements playback control by using a content address setting service and a content playback control service provided by the content playback terminal 300.

Even after playing back the content, the mobile terminal 120 can receive an input command about the playback control of the content, which is inputted by the user, such as a pause, playback restart, fast forward, rewinding, or stop command, through the input means 101, and carries out content playback control using the content playback control service provided by the content playback terminal 300 (in step ST1805). The content continuous playback control means 106 checks to see whether or not the command inputted by the user is the stop command, and whether or not a power supply off-button is pushed (in step ST1806), and when determining that the command inputted by the user is the stop command or the power supply off-button is pushed, stops the playback of the content and carries out screen control so that the user interface switches back to the user interface screen display shown in FIG. 19. At this time, the content continuous playback control means 106 acquires the playback position of the content by using a terminal status acquisition service provided by the content playback terminal 300, and updates the corresponding playback stop position field 1606 of the content playback conditions table (in step ST1807).

When the command inputted by the user in step ST1806 is not the stop command and the power supply off-button is not pushed, the content continuous playback control means 106 repeats the process of step ST1805.

As mentioned above, since the continuous content playback system according to embodiment 4 holds the playback stop position as information about the playback position when the content playback terminal stops the playback of the content while playing back the content, the continuous content playback system makes it possible for the user to easily enjoy the rest of each of two or more contents which he or she has watched up to the middle. When the user uses the mobile terminal while walking around away from home, he or she can view and listen to the rest of each of two or more contents which he or she has watched up to the middle by searching for desired content again through the network to which the mobile terminal is connected when selecting the desired content and by referring to the content playback conditions table, even through the user is staying in a vehicle in which the network is disposed, or in his or her friend's house or the like, for example.

### Embodiment 5

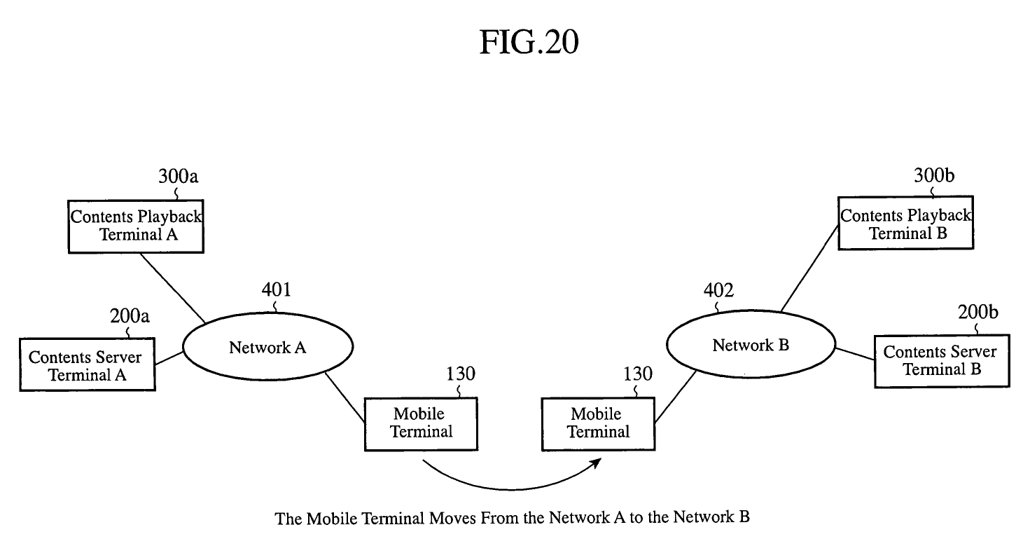

FIG. 20 is a block diagram showing a continuous content playback system according to embodiment 5. In the figure, a content server terminal A 200a, a content server terminal B 200b, and each of content playback terminals A and B (300a and 300b) have the same functions as the content server terminals A and B (200a and 200b) and content playback terminal 300, as shown in FIG. 1 of embodiment 1, respectively, and the explanation of the components will be omitted hereafter.

A mobile terminal 130 does not have any recorder for recording content thereinto and does not have any function of playing back content, and a detailed explanation of the mobile terminal will be made below. A network A 401 provides a communications path which make it possible for the content playback terminal A 300a, content server terminal A 200a, and mobile terminal 130 to communicate with one another, and a network B 402 provides a communications path which make it possible for the content playback terminal B 300b, content server terminal B 200b, and mobile terminal 130 to communicate with one another. The network A 401 and network B 402 can be independent networks which do not have a route which connects between the networks, and can alternatively have a route which connects between the networks. In either case, when the user carries the mobile terminal 130, the mobile terminal 130 can be connected to either of the network A 401 and network B 402. Although only a single content server terminal and a single content playback terminal are disposed in each of the networks A and B (401 and 402), two or more content server terminals and two or more content playback terminals can be disposed in each of the networks A and B (401 and 402).

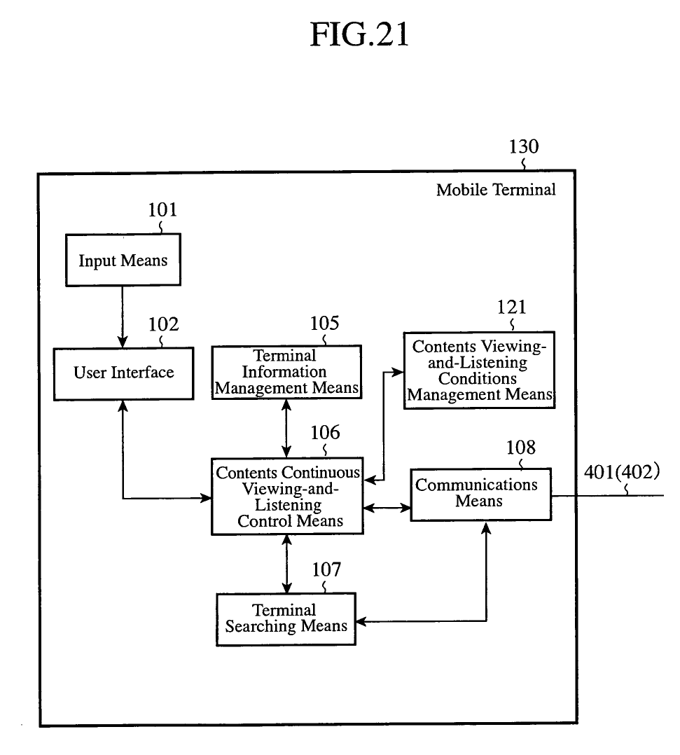

FIG. 21 is a diagram showing the detailed structure of the mobile terminal 130 according to embodiment 5. Unlike the mobile terminal 120 according to embodiment 4 shown in FIG. 15, the mobile terminal 130 shown in FIG. 21 does not include a content playback means 103 and a content storage means 104. Blocks denoted by the same reference numerals as shown in FIG. 15 have the same functions as those of the mobile terminal 120 of embodiment 4, respectively, and the explanation of the blocks will be omitted hereafter.

Hereafter, the operation of the mobile terminal 130 in accordance with this embodiment will be explained. First, assume that the mobile terminal 130 is connected to the network A 401 shown in FIG. 20. Since the mobile terminal 130 itself does not have any content and cannot play back any content, the mobile terminal 130 acquires a list of content stored in the content server terminal A 200a, and generates a user interface screen display as shown in FIG. 17 on a user interface 102 included therein. Through this user interface screen display, the user can select content so as to view and listen to the content using the content playback terminal A 300a. As shown in embodiment 4, when the user stops viewing and listening to the content or turns off the power, the mobile terminal extracts a stop point at which the playback of the content is paused, and tells the content playback terminal A 300a to update the playback stop position 1606 illustrated in FIG. 16.

Thus, the mobile terminal 130 in accordance with this embodiment does not have an ability to play back desired content, but can instruct the content server terminal and content playback terminal which are connected to the network to play back the desired content and can store an ID specifying the content, a playback stop position specified by the user, etc. in the content playback conditions management means 121 included therein. The user can carry the mobile terminal 130.

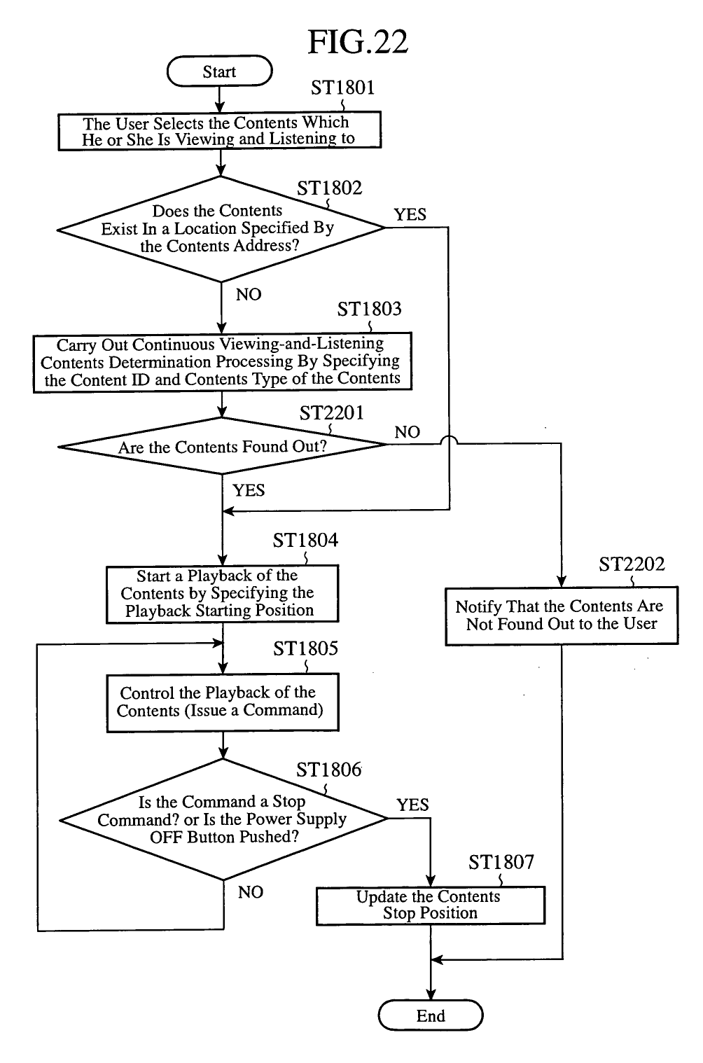

Next, the description is directed to the operation of the mobile terminal 130 at a time when the user moves with the mobile terminal 130 and connects this mobile terminal to the network B 402 so as to continuously view and listen to specific content. FIG. 22 is a flow chart showing the operation of the mobile terminal 130 in the continuous content playback system according to embodiment 5. The operation of the mobile terminal according to this embodiment differs from that of the mobile terminal according to embodiment 4 only in that the mobile terminal determines whether or not there is a case where content are not found out in carrying out continuous playback content determination processing. Therefore, in FIG. 22, the same processes as shown in the flow chart of FIG. 18 showing the operation of the mobile terminal in accordance with embodiment 4 are denoted by the same step numbers, and the explanation of the processes will be omitted hereafter. In other words, the steps other than steps ST2201 and ST2202 are the same as those of the operation of the mobile terminal in accordance with embodiment 4 shown in FIG. 18.

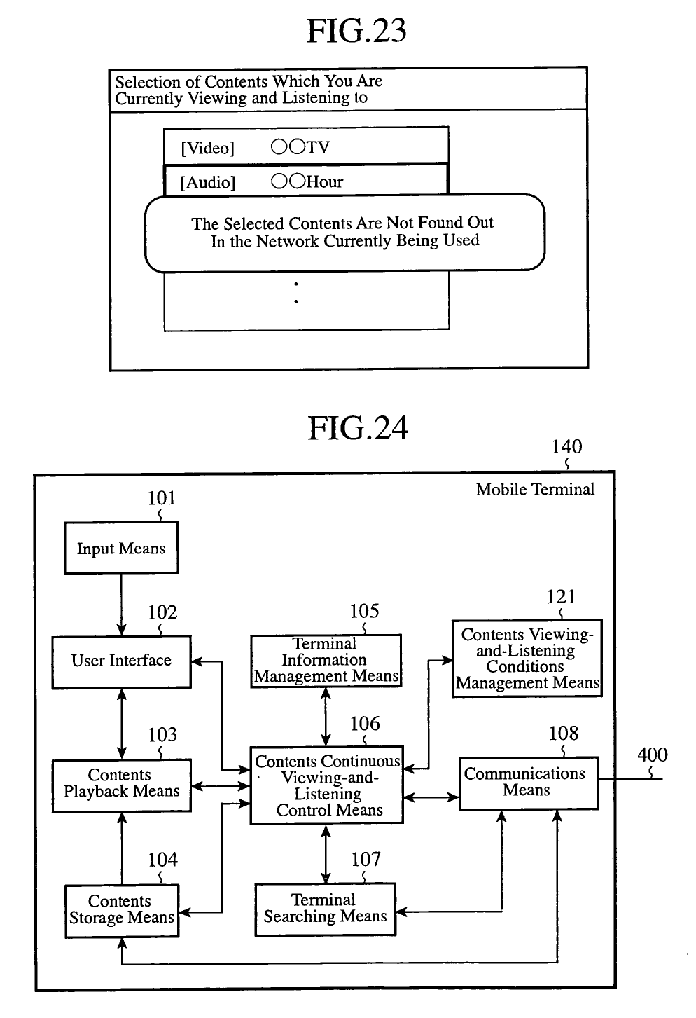

In step ST2201, the mobile terminal 130 carries out the continuous playback content determination processing so as to specify the content ID and content type of the content, and to search for metadata about the content through a content server terminal B 200b on the network 402 (in step ST2201). When not finding out corresponding metadata about the content even if searching through all other content server terminals B 200b, the mobile terminal 130 advances the processing to step ST2202. On the other hand, when finding out corresponding metadata about the content, the mobile terminal 130 advances the processing to step ST1804 in which it starts a playback of the content. The mobile terminal 130, in step ST2202, provides an message, as shown in FIG. 23, indicating the fact that it cannot find out corresponding metadata about the content for the user, and aborts the processing associated with the viewing and listening of the content which the user desired to continuously view and listen to.

As mentioned above, in the continuous content playback system according to embodiment 5, when a content playback terminal stops a playback of content while playing back the content, the mobile terminal holds a playback stop position as information about the playback position of the content. Therefore, even when having no ability to store content therein and play back content, the mobile terminal can easily make it possible for the user to continuously view and listen to desired content by managing the playback stop position of the content even if the mobile terminal is connected to a network different from the network of the content playback terminal from which the mobile terminal has been receiving the content for the user's viewing and listening.

As previously mentioned, the continuous content playback system according to above-mentioned embodiment 5 has the same structure as that of embodiment 1 in which a content server terminal 200 and a content playback terminal 300 are disposed in each network A or B (401 or 402). As an alternative, the continuous content playback system according to above-mentioned embodiment 5 can have the same structure as that of embodiment 2 in which a content playback server terminal 500 is disposed in each network A or B (401 or 402).

### Embodiment 6

FIG. 24 is a block diagram showing a mobile terminal 140 in a continuous content playback system according to embodiment 6. As shown in the figure, the mobile terminal 140 is provided with an input means 101, a user interface 102, a content playback means 103, a content storage means 104, a terminal information management means 105, a content continuous playback control means 106, a terminal searching means 107, a communications means 108, and a playlist management means 141. Hereafter, the input means 101, user interface 102, content playback means 103, content storage means 104, terminal information management means 105, content continuous playback control means 106, terminal searching means 107, and communications means 108 are the same as those of embodiment 1 shown in FIG. 2, and the explanation of these components will be omitted hereafter. The playlist management means 141 manages a list of content metadata which the mobile terminal 140 has acquired. A network to which the mobile terminal 140 is connected can have such a structure as shown in either of embodiments 1 and 2. Hereafter, assuming that the network has a structure shown in FIG. 1, the operation of the continuous content playback system will be explained with reference to FIG. 1.

In accordance with this embodiment, the mobile terminal 140 periodically examines a playback state of playing back specific content of a content playback terminal at short time intervals, and refers to the content list continuously managed by the playlist management means 141 and automatically makes a request of the content playback terminal for playback of the next content even if the content playback terminal has completed a playback of specific content which are a target for continuous playback.

Hereafter, how the mobile terminal 140, content playback terminal 300, and content server terminal 200 which are shown in embodiment 6 implement an automatic playback of content included in the content list managed by the playlist management means 141 in cooperation with one another will be explained.

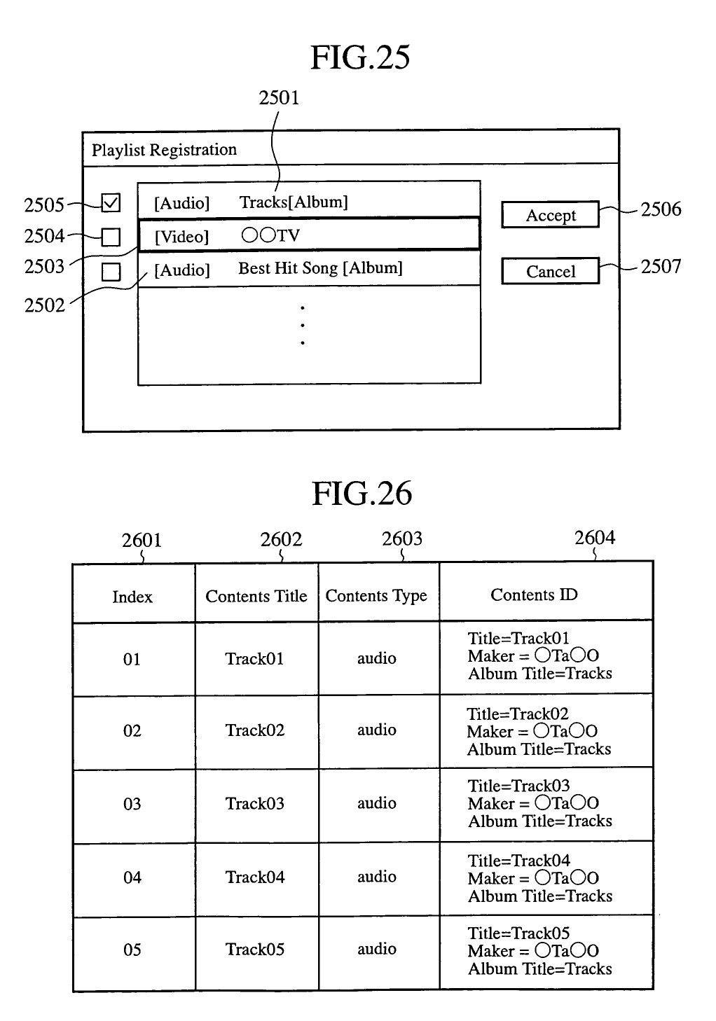

The mobile terminal 140 acquires content from the communications means 108, a not shown flash memory terminal or the like, and records them in the content storage means 104 while associating them with metadata. The content continuous playback control means 106 of the mobile terminal 140 acquires metadata about content stored in the content storage means 104, and provides the acquired metadata to the user interface 102. As a result, the user interface 102 generates a user interface screen display for playlist registration as shown in FIG. 25.

In FIG. 25, each title 2501 indicates the title of corresponding content, information included in a parenthesis showing whether the content relate to an album. Each content type 2502 indicates the type of corresponding content, a cursor 2503 indicates content which the user is selecting, a check box 2504 is the one which the user checks when registering corresponding content into the playlist, a check mark 2505 indicates that corresponding content are being selected by the user, an accept button 2506 is the one which the user clicks when registering corresponding content into the playlist, and a cancel button 2507 is the one which the user clicks when canceling the registration of corresponding content into the playlist.

When receiving a notification that the user has manipulated a user interface screen display as shown in FIG. 25, and has pushed the accept button 2506 from the user interface 102, the content continuous playback control means 106 registers metadata about the content for which the check mark 2505 is placed into the playlist management means 141. The user is allowed to register a music album or the like into the playlist at once by checking the corresponding check box 2504. For example, in the example of FIG. 25, the user can register all tracks of an album into the playlist at once by checking the check box 2504 corresponding to “the song best hit [album]”.

An example in which a music album is registered into the playlist stored in the playlist management means 141 is shown in FIG. 26. In FIG. 26, each index field 2601 is information indicating the order of corresponding content in the playlist, a content title field 2602 indicates the title of corresponding content, each content type field 2603 indicates the type of corresponding content, and each content ID field 2604 is identification information for specifying corresponding content.

Hereafter, a process of switching from the mobile terminal 140 to the content playback terminal 300 for a continuous playback of a track having an index of 03 which is included in the playlist shown in FIG. 26 while the user is viewing and listening to the music with the mobile terminal 140 will be explained as an example.

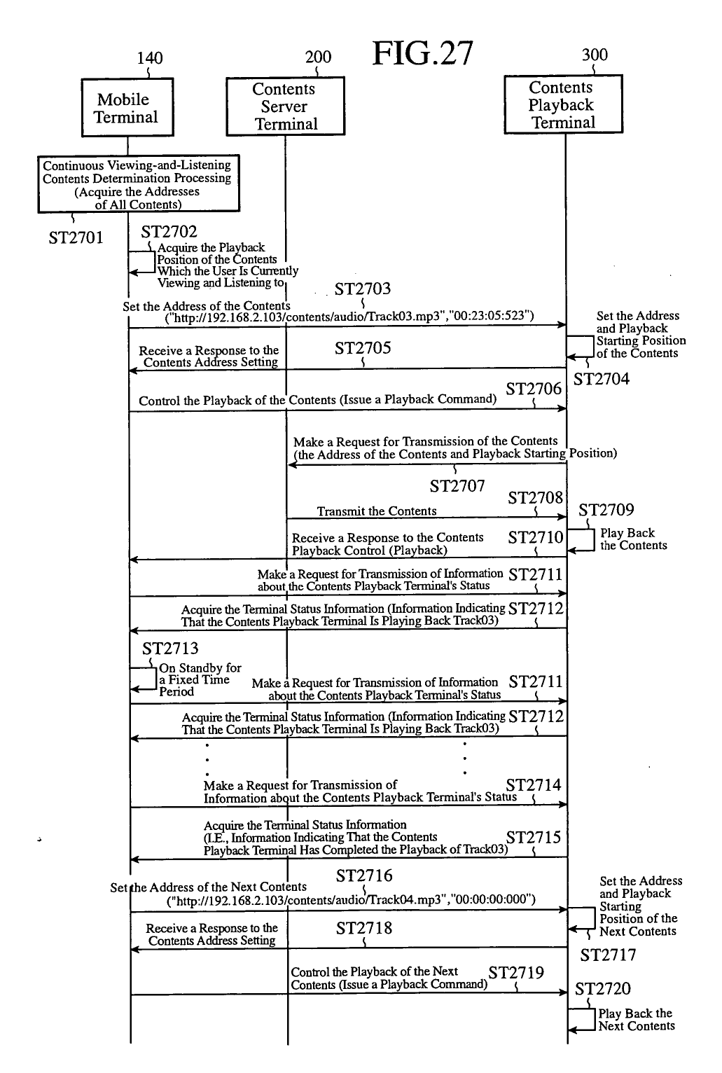

FIG. 27 is a sequence diagram showing this process. The content continuous playback control means 106 of the mobile terminal 140 carries out continuous playback content determination processing first, and acquires the content address of each of all the content registered into the playlist shown in FIG. 26 (in step ST2701). The content continuous playback control means 106 further acquires the playback position of the specific content which the user is currently viewing and listening to from the content playback means 103 (in step ST2702). In this case, since the user is currently viewing and listening to the track having an index of 03 which is registered into the playlist, the content continuous playback control means 106 acquired http://192.168.2.103/content/audio/Track03.mp3 as the content address, and, 00:23:05.523 as the playback position, and sets them as parameters for a content address setting service provided by the content playback terminal 300 (in step ST2703). Since steps ST2704 to ST2710 are the same as steps ST514 to step ST520 of FIG. 5 which are already explained in embodiment 1, the explanation of those steps will be omitted hereafter.

The mobile terminal 140 then uses a terminal status acquisition service provided by the content playback terminal 300 so as to check the playback state of playing back the specific content at fixed time intervals (in step ST2711). The mobile terminal 140 receives status information of the content playback terminal 300 from the content playback terminal 300. Especially, in this example, the mobile terminal 140 receives information indicating that the user is currently viewing and listening to the track “Track03” having an index of 03 which is registered into the playlist (in step ST2712). Then, after waiting for a fixed time period, the mobile terminal 140 makes a request of the content playback terminal 300 for transmission of the status information of the content playback terminal again (in step ST2711), and checks a response (in step ST2712). After periodically continuing checking the content playback state of the content playback terminal in this way, the mobile terminal 140, in step ST2715, acquires status information indicating that the content playback terminal has completed the playback of the specific content as a response to a terminal status acquisition request in step ST2714.

When determining that the content playback terminal 300 has completed the playback of the specific content, the content continuation playback control means 106 included in the mobile terminal 140 makes a request of the content playback terminal 300 for provision of the content address setting service by specifying http://192.168.2.103/content/audio/Track04.mp3, as the content address of the next track having an index of 04 which is registered into the playlist, and 00:00:00.000 as the playback position of the next track, so that the content playback terminal 300 starts a playback of the next track from the head of the music (in step ST2716). Since the following steps ST2717 to ST2720 are the same as steps ST514 to ST519 of FIG. 5 which are already explained in embodiment 1, the explanation of those steps will be omitted hereafter. The content playback terminal 300 thus starts a playback of the next music having an index of 04 under control of steps ST2717 to ST2720.

In accordance with above-mentioned embodiment, the mobile terminal 140 checks the status of the content playback terminal 300 at fixed time intervals so as to determine a timing with which it controls the playback of the next content listed in the playlist. As an alternative, the content playback terminal 300 can notify the mobile terminal 140 that the content playback terminal 300 has completed the playback of the content so as to determine the timing.

By pre-providing information about each content included in the playlist created by the mobile terminal 140 for the content playback terminal 300 at once, the continuous content playback system makes it possible for the content playback terminal 300 to continuously play back subsequent tracks included in the playlist without any content control by the mobile terminal 140.

As mentioned above, in the continuous content playback system according to embodiment 6, the mobile terminal manages a list of two or more contents to be played back as a playlist, and has the playlist management means for, when the content playback terminal has completed the playback of specific content which it has been playing back, making a request of the content playback terminal to play back subsequent content included in the playlist in order. Therefore, the content playback terminal can not only carry out a continuous playback of only single content which the user has been viewing and listening to with the mobile terminal, but also continuously play back two or more contents registered into the playlist. As a result, when the user wants to listen to all tracks of a music album in turn, for example, the content playback terminal makes it possible for the user to continuously enjoy all subsequent content in which importance is placed on the order in which they are played back without losing the playback order and flow.

As previously mentioned, the continuous content playback system according to embodiment 6 is provided with the content playback terminal 300 according to embodiment 1. As an alternative, the continuous content playback system can be provided with the content playback terminal 310 according to embodiment 3. Furthermore, the mobile terminal 140 can be provided with the content viewing conditions management means 121 according to embodiment 4.

Many widely different embodiments of the present invention may be constructed without departing from the spirit and scope of the present invention. It should be understood that the present invention is not limited to the specific embodiments described in the specification, except as defined in the appended claims.

What is claimed is:

1. A continuous content playback system comprising:
a content server for storing content;
a content playback terminal for playing back content stored in said content server; and
a mobile terminal for holding identification information indicating specific content which a user has been viewing and listening to, and a playback position of the specific content, for, when receiving an instruction for continuous playback of the specific content, acquiring a storage location of said specific content in said content server based on said held identification information indicating the specific content, and notifying this storage location to said content playback terminal, and for specifying a playback starting position based on said held playback position to provide an instruction for continuous playback of said specific content,
wherein when receiving the instruction of continuous playback from said mobile terminal, said content playback terminal reads the specific content from the storage location in said content server and carries out a continuous playback of said specific content from said playback starting position according to the instruction.

2. A continuous content playback system comprising:
a content server for storing and playing back content; and
a mobile terminal for holding identification information indicating specific content which a user has been viewing and listening to, and a playback position of the specific content, for, when receiving an instruction for continuous playback of the specific content, acquiring a storage location of said specific content in said content server based on said held identification information indicating the specific content, and notifying this storage location to said content playback terminal which is to play back the specific content, and for specifying a playback starting position based on said held playback position to provide an instruction for continuous playback of said specific content,
wherein when receiving the instruction for continuous playback from said mobile terminal, said content playback terminal reads the specific content from said content server having the notified storage location and carries out a continuous playback of said specific content from said playback starting position according to the instruction.

3. The continuous content playback system according to claim 1, wherein said mobile terminal is provided with a content storage means for storing content, and a content playback means for playing back the content stored in said content storage means, and holds identification information indicating content which have been being played back by said content playback means and a playback position of the content.

4. The continuous content playback system according to claim 1, wherein said content playback terminal searches for a mobile terminal which is specified in advance, and, when the specific mobile terminal exists, notifies a fact that said content playback terminal can carry out a continuous playback of content to said mobile terminal.

5. The continuous content playback system according to claim 3, wherein said content playback terminal searches for a mobile terminal which is specified in advance, and, when the specific mobile terminal exists, notifies a fact that said content playback terminal can carry out a continuous playback of content to said mobile terminal.

6. The continuous content playback system according to claim 1, wherein said mobile terminal searches for a content playback terminal which is specified in advance, and, when the specific content playback terminal exists, determines the content playback terminal as a content playback terminal which carries out a continuous playback of the specific content.

7. The continuous content playback system according to claim 3, wherein said mobile terminal searches for a content playback terminal which is specified in advance, and, when the specific content playback terminal exists, determines the content playback terminal as a content playback terminal which carries out a continuous playback of the specific content.

8. The continuous content playback system according to claim 1, wherein said mobile terminal sends playback control information about the specific content to said content playback terminal, and said content playback terminal carries out playback control of the specific content based on said playback control information.

9. The continuous content playback system according to claim 3, wherein said mobile terminal sends playback control information about the specific content to said content playback terminal, and said content playback terminal carries out playback control of the specific content based on said playback control information.

10. The continuous content playback system according to claim 1, wherein when said content playback terminal stops playing back content while it is playing back the content, said mobile terminal holds a stop position of the content at which said content playback terminal has stopped the playback as information about the playback position.

11. The continuous content playback system according to claim 3, wherein when said content playback terminal stops playing back content while it is playing back the content, said mobile terminal holds a stop position of the content at which said content playback terminal has stopped the playback as information about the playback position.

12. The continuous content playback system according to claim 1, wherein said mobile terminal manages a playback list of two or more contents including the specific content as a playlist, and includes a playlist management means for, when said content playback terminal has completed the playback of the specific content, making a request of said content playback terminal for continuous playback of subsequent content listed in said playlist in order.

13. The continuous content playback system according to claim 3, wherein said mobile terminal manages a playback list of two or more contents including the specific content as a playlist, and includes a playlist management means for, when said content playback terminal has completed the playback of the specific content, making a request of said content playback terminal for continuous playback of subsequent content listed in said playlist in order.
